(19) United States
(12) Patent Application Publication
(10) Pub. No.: US 2009/0134282 A1
(43) Pub. Date: May 28, 2009

(54) PIPE CLAMP

(76) Inventor: Glenn R. Grim, Sr., Charlotte, NC (US)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/944,780

(22) Filed: Nov. 26, 2007

(51) Int. Cl. F16L 3/12

(52) U.S. Cl. 248/56

(57) ABSTRACT

A pipe clamp includes an elongate base having first and second spaced-apart holes for receiving respective fasteners for attaching the clamp to a support, and at least one clamping element extending outwardly from the base between the first and second holes for receiving and supporting a pipe, and for allowing the clamp to be attached to and removed from the support without removing the pipe. A method of forming a pipe clamp is also disclosed.

### TECHNICAL FIELD AND BACKGROUND OF THE INVENTION

This invention relates to clamps, and particularly to clamps of the type used to attach electrical conduit to building supports such as wall studs, beams and similar structural components. Pipe clamps of prior art design are either unduly complicated or are formed in such a way that the clamp is fastened to the support directly behind the pipe location. This means that the clamp cannot be attached to a support behind an existing pipe without first removing the pipe, and cannot be removed from the support without first removing the pipe. There exists a need for a pipe clamp that permits the clamp to be inserted behind a pipe already in position on a support and attached without moving the pipe, and that can be removed without moving the pipe.

### SUMMARY OF THE INVENTION

Therefore, it is an object of the invention to provide an inexpensive and efficient pipe clamp.

It is another object of the invention to permits the clamp to be inserted behind a pipe already in position on a support and attached without moving the pipe, and that can be removed without moving the pipe.

These and other objects and advantages are provided by a pipe clamp, comprising an elongate base having first and second spaced-apart holes for receiving respective fasteners for attaching the clamp to a support; and at least one clamping element extending outwardly from the base between the first and second holes for receiving and supporting a pipe, and for allowing the clamp to be attached to and removed from the support without removing the pipe.

According to one embodiment of the invention, the base and clamping element are integrally-formed.

According to one embodiment of the invention, the base and clamping element are separate components attached to each other.

According to one embodiment of the invention, the at least one clamping element comprises a pair of laterally spaced-apart legs for retaining a pipe therebetween.

According to one embodiment of the invention, the base includes a fastener hole between the pair of legs.

According to one embodiment of the invention, the pair of legs include tightening means for allowing the legs to be tightened against the pipe.

According to one embodiment of the invention, the clamping element comprises first and second legs formed from base material.

According to one embodiment of the invention, the first and second legs comprise elongate sections cut from the base and bent into respective positions extending outwardly from the base.

According to one embodiment of the invention, the clamping element is welded to the base.

According to one embodiment of the invention, the laterally spaced-apart legs each include arcuate sections for receiving and positioning a pipe therebetween.

According to one embodiment of the invention, a pipe clamp is provided, comprising an elongate base for being attached to a support in two spaced-apart locations along a longitudinal axis of the base, and at least one clamping element extending outwardly from the base between the two spaced-apart locations for receiving and supporting a pipe, and for allowing the clamp to be attached to and removed from the support without removing the pipe.

The invention also includes a method of forming a pipe clamp, comprising the steps of forming a substantially planar base, providing first and second spaced-apart fastener locations in the base for fastening the clamp to a support, and providing a clamping element on the base between the first and second spaced-apart fastener locations for receiving a pipe therein.

According to one embodiment of the invention, the step of providing first and second fastener locations comprises the step of forming first and second holes in the base.

According to one embodiment of the invention, the step of providing a clamping element on the base comprises the step of attaching two spaced-apart and outwardly-extending legs to the base.

According to one embodiment of the invention, the step of providing a clamping element on the base comprises the step of forming two spaced-apart and outwardly-extending legs from the material of the base.

### BRIEF DESCRIPTION OF THE DRAWINGS

The invention is now further described with reference to the drawings, in which:

FIG. 1 is a perspective view of one embodiment of a pipe clamp according to the invention;

FIG. 2 is a perspective view of another embodiment of a pipe clamp during formation;

FIG. 3 is a perspective view of the pipe clamp of FIG. 2, as formed; and

FIG. 4 shows attachment of the pipe clamp of FIG. 1 to a support.

### DETAILED DESCRIPTION OF PREFERRED EMBODIMENT AND BEST MODE

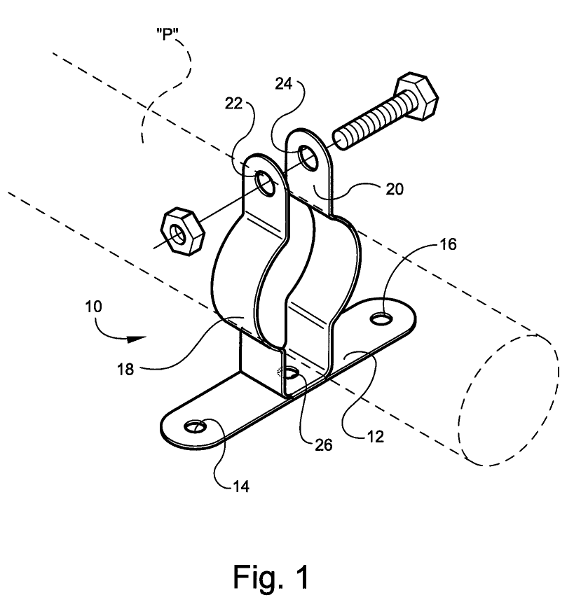

Referring now to the drawings, a pipe clamp according to one embodiment of the invention is shown in FIG. 1 at broad reference numeral 10. The clamp 10 is preferably formed of stamped, galvanized metal, such as, by way of example, 20 gauge galvanized steel. Clamp 10 includes a base 12 that is provided with fastener holes 14, 16 near its opposite ends. A U-shaped clamping element 17 is attached, as by welding, to the base between the two holes 14, 16, and includes two outwardly-extending legs 18, 20 connected by a bridging member 19. As is shown, the legs 18, 20 each have outwardly-bowed arcuate sections for receiving a pipe “P”. See also FIG. 4. The legs 18, 20 have respective holes 22, 24 for receiving a bolt and nut or some other fastening element for securing the pipe “P” into the clamp 10. If desired, the clamp may also be attached to a support by a fastener through a hole 26 that extends through both the bridging member 19 of the clamping element 17 and the base 12.

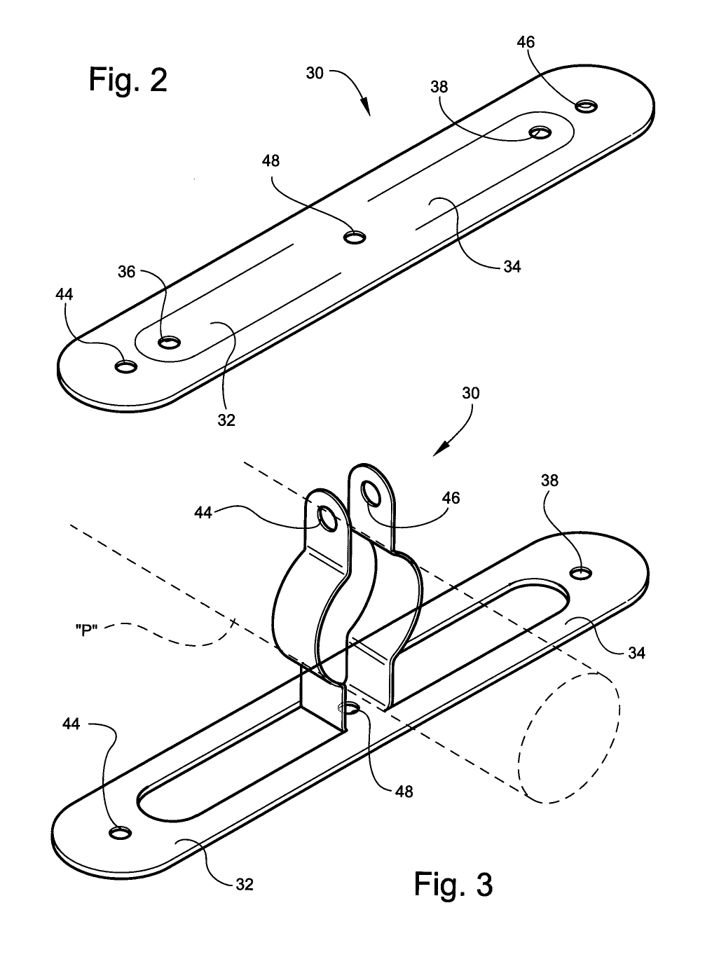

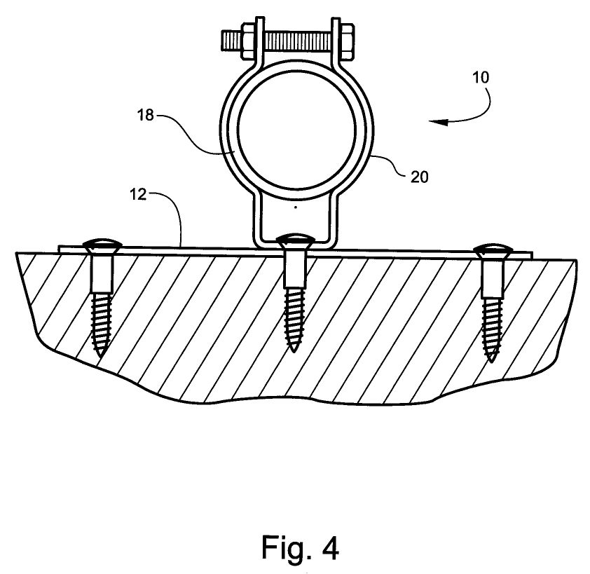

Referring now to FIGS. 2 and 3, an alternative embodiment of a pipe clamp according to the invention is shown at reference numeral 30. The clamp 30 is formed of a single piece of galvanized steel. Two elongate base members 32, 34 are cut into the clamp 30 and are maintained in aligned position in the same plane. Holes 36, 38 in respective ones of the base members 32, 34 allow the clamp to be fastened to a support, for example, with screws or bolts.

The legs 40, 42 are formed by bending them into substantially right angles to the base members 32, 34, and forming them into a bowed-out, arcuate configuration appropriate to allow a pipe to be snapped into position between the legs 40, 42. The legs 40, 42 have respective holes 44, 46 for receiving a bolt and nut or some other fastening element for securing the pipe “P” into the clamp 30. A hole 48 in the middle of the clamp 30 allows the clamp 30 to be attached at the middle point of the clamp 30, as well.

As with the clamp 10, the clamp 30 can be attached to a support by placing it behind the pipe “P” with the pipe “P” between the legs 40, 42, and then screwing the clamp 30 into place on the support. Clamp 30 has the advantage of being formed from a single piece of material, thereby using less material and not requiring a welding or other attachment process. The base members 32, 34 can be quickly formed by stamping, laser or plasma cutting or other process and bent into shape in a single, automated process.

A pipe clamp and method for forming a pipe clamp are described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1-15. (canceled)

16. A pipe clamp forming blank, comprising:
a blank including first and second elongate base members symmetrical about a lateral axis of the blank;
first and second fastener holes defined through opposing ends of the first and second elongate base members;
first and second legs defined in the interior of the first and second elongate base members, respectively, symmetrical about the lateral axis for being bent away from the first and second elongate base members and toward each other to be bent to cooperatively form a pipe clamping portion; and
third and fourth fastener holes defined through opposing ends of the first and second legs for cooperatively receiving a fastening element for securing a pipe within the pipe clamping portion.

17. The pipe clamp forming blank according to claim 16, further comprising a fifth fastener hole defined through the blank positioned along the lateral axis of the blank.

18. The pipe clamp forming blank according to claim 16, wherein adjacent ends of the first and second legs are spaced apart.

19. The pipe clamp forming blank according to claim 16, further comprising a fifth fastener hole defined through the blank positioned between the first and second legs.

20. The pipe clamp forming blank according to claim 16, wherein the first and second elongate base members are U-shaped.

21. The pipe clamp forming blank according to claim 16, wherein the first and second legs are U-shaped.

22. The pipe clamp forming blank according to claim 16, wherein the blank is constructed of galvanized metal.
